(19) United States
(12) Patent Application Publication
(10) Pub. No.: US 2021/0033316 A1
(43) Pub. Date: Feb. 4, 2021

(54) OIL PUMP CONTROL DEVICE, CONTROL METHOD, CONTROL PROGRAM, AND TURBO REFRIGERATOR

(71) Applicant: MITSUBISHI HEAVY INDUSTRIES THERMAL SYSTEMS, LTD., Tokyo (JP)

(72) Inventors: Yoshie TOGANO, Tokyo (JP); Kenji UEDA, Tokyo (JP); Yasushi HASEGAWA, Tokyo (JP)

(73) Assignee: MITSUBISHI HEAVY INDUSTRIES THERMAL SYSTEMS, LTD., Tokyo (JP)

(21) Appl. No.: 16/767,039

(22) PCT Filed: Nov. 16, 2018
(86) PCT No.: PCT/JP2018/042414

§ 371 Date: May 26, 2020

(30) Foreign Application Priority Data
Dec. 19, 2017 (JP) 2017-242823

(51) Int. Cl. F25B 31/00; F04B 49/06; F04D 29/063

(52) U.S. Cl. CPC F25B 31/004; F04D 29/063; F04B 49/06

(57) ABSTRACT

In order to reduce the effect of foaming occurring in an oil tank on a compressor, an oil pump control unit (50) is applied to a turbo refrigerator comprising an oil tank that stores lubrication oil supplied to a compressor and a variable-speed oil pump that supplies the lubricating oil in the oil tank to the compressor. The oil pump control unit (50) comprises: an intake refrigerant gas amount calculation unit (52) for calculating the amount of refrigerant gas drawn into the oil pump, as an intake refrigerant gas amount; a supplied lubricating oil amount calculation unit (53) for using the intake refrigerant gas amount and a required lubricating oil amount, which is an amount of lubricating oil required by the compressor, to calculate a supplied lubricating oil amount; and a command value generation unit (54) for generating a rotation speed command value for the oil pump on the basis of the supplied lubricating oil amount.

### TECHNICAL FIELD

The present invention relates to a centrifugal chiller, and more particularly, to an oil pump control device, a control method, and a control program for controlling an oil pump provided in a centrifugal chiller.

### BACKGROUND ART

In related art, an HFC refrigerant used for a centrifugal chiller has a Global Warming Potential (GWP) value in the hundreds to thousands, and thus, it is necessary to switch from the HFO refrigerant having a GWP value in the hundreds to thousands of GWP to an HFO refrigerant having a GWP value of one digit in consideration of an environment. In order to cope with this, a low-pressure refrigerant such as HFO-1233zd (E) may be used as a refrigerant for a chiller.

In general, the centrifugal chiller has an oil tank in which a lubricant supplied to a turbo compressor is stored. Here, a specific volume of a refrigerant gas of HFO-1233zd (E) is about five times that of HFC-134a. In general, the low-pressure refrigerant has a gas specific volume larger than that of a high-pressure refrigerant. Accordingly, compared to a chiller which uses a high-pressure refrigerant, in a chiller which uses a low-pressure refrigerant, in a case where the refrigerant is generated in a state in which a pressure of the refrigerant having the same mass dissolved into the lubricant in the oil tank decreases, a volume of the generated refrigerant increases, and foaming easily occurs in the lubricant in the oil tank. Particularly, at the time of startup where a pressure reduction speed on a low-pressure side is large, foaming easily occurs in the lubricant in the oil tank.

PTL 1 discloses that when a compressor starts, after the starting is performed at an opening degree at which an opening degree of a suction capacity control unit is smaller than a target opening degree, the opening degree rapidly increases to the target opening degree such that an operation time in which the opening degree is less than the target opening degree can be set as short as possible to reduce a passage resistance of the refrigerant, and a decrease in a pressure on a downstream side of the suction capacity control unit is suppressed so as to suppress occurrence of foaming.

### CITATION LIST

### Patent Literature

[PTL 1] Japanese Unexamined Patent Application Publication No. 2009-186030

### SUMMARY OF INVENTION

### Technical Problem

If an amount of foaming is large, a refrigerant gas is caught in an oil pump, a predetermined amount of oil cannot be supplied to a compressor bearing, and thus, the compressor is likely to be damaged.

The present invention is made in consideration of the above-described circumstances, and an object thereof is to provide an oil pump control device, a control method, a control program, and a centrifugal chiller capable of reducing an influence on the compressor due to occurrence of foaming in an oil tank.

### Solution to Problem

According to a first aspect of the present invention, there is provided an oil pump control device which is applied to a centrifugal chiller including an oil tank for storing a lubricant to be supplied to a compressor, and an oil pump having a variable rotating speed and supplying the lubricant in the oil tank to the compressor, the control device including: a suction refrigerant gas amount calculation unit which calculates an amount of refrigerant gas sucked by the oil pump, as a suction refrigerant gas amount; a supply lubricant amount calculation unit which calculates a supply lubricant amount using the suction refrigerant gas amount and a required lubricant amount which is a lubricant amount required by the compressor; and a command value generation unit which generates a rotating speed command value of the oil pump based on the supply lubricant amount.

According to the oil pump control device, the amount of refrigerant gas sucked by the oil pump is calculated as the suction refrigerant gas amount by the suction refrigerant gas amount calculation unit, and the supply lubricant amount is calculated by the supply lubricant amount calculation unit using the suction refrigerant gas amount and the required lubricant amount which is the amount of lubricant required by the compressor. In addition, the command value generation unit generates the rotating speed command value of the oil pump based on the supply lubricant amount.

As described above, the supply lubricant amount is calculated in consideration of the refrigerant gas amount sucked by the oil pump, and the rotating speed of the oil pump is controlled according to the supply lubricant amount. Accordingly, it is possible to prevent the amount of lubricant supplied to the compressor being insufficient due to occurrence of foaming.

In the oil pump control device, the suction refrigerant gas amount calculation unit may include a first calculation unit which calculates an amount of refrigerant gas generated from the lubricant in the oil tank, and a second calculation unit which calculates the amount of refrigerant gas sucked by the oil pump using the amount of refrigerant gas calculated by the first calculation unit.

According to the oil pump control device, the first calculation unit calculates the amount of refrigerant gas generated from the entire lubricant stored in the oil tank, and the second calculation unit calculates the amount of refrigerant gas sucked by the oil pump out of the calculated amount of refrigerant gas. Accordingly, it possible to obtain the amount of refrigerant gas which affects the amount of lubricant to be supplied to the compressor, and to calculate an appropriate supply lubricant amount.

According to a second aspect of the present invention, there is provided a centrifugal chiller including: a compressor which compresses a refrigerant; a condenser which condenses the refrigerant compressed by the compressor; an expansion valve which expands a liquid refrigerant introduced from the condenser; an evaporator which evaporates the refrigerant expanded by the expansion valve; an oil tank which stores a lubricant to be supplied to the compressor; an oil pump which has a variable rotating speed and supplies the lubricant in the oil tank to the compressor; and the oil pump control device.

According to a third aspect of the present invention, there is provided an oil pump control method which is applied to a centrifugal chiller including an oil tank for storing a lubricant to be supplied to a compressor, and an oil pump having a variable rotating speed and supplying the lubricant in the oil tank to the compressor, the control method including: a step of calculating an amount of refrigerant gas sucked by the oil pump, as a suction refrigerant gas amount; a step of calculating a supply lubricant amount using the suction refrigerant gas amount and a required lubricant amount which is a lubricant amount required by the compressor; and a step of generating a rotating speed command value of the oil pump based on the supply lubricant amount.

According to a fourth aspect of the present invention, there is provided an oil pump control program which is applied to a centrifugal chiller including an oil tank for storing a lubricant to be supplied to a compressor, and an oil pump having a variable rotating speed and supplying the lubricant in the oil tank to the compressor, the control program causing a computer to execute: processing of calculating an amount of refrigerant gas sucked by the oil pump, as a suction refrigerant gas amount; processing of calculating a supply lubricant amount using the suction refrigerant gas amount and a required lubricant amount which is a lubricant amount required by the compressor; and processing of generating a rotating speed command value of the oil pump based on the supply lubricant amount.

### Advantageous Effects of Invention

According to the present invention, it is possible to reduce an influence on the compressor due to occurrence of foaming in an oil tank.

### BRIEF DESCRIPTION OF DRAWINGS

FIG. 1 is a schematic configuration diagram illustrating a centrifugal chiller according to an embodiment of the present invention.

FIG. 2 is a diagram schematically illustrating a configuration of an oil tank according to an embodiment of the present invention.

FIG. 3 is a functional block diagram of an oil pump control unit according to an embodiment of the present invention.

FIG. 4 is a diagram illustrating an example of refrigerant solubility information.

FIG. 5 is a flowchart illustrating a procedure of an oil pump control method according to an embodiment of the present invention.

### DESCRIPTION OF EMBODIMENTS

Hereinafter, an oil pump control device, a control method, a control program, and a centrifugal chiller according to an embodiment of the present invention will be described with reference to the drawings.

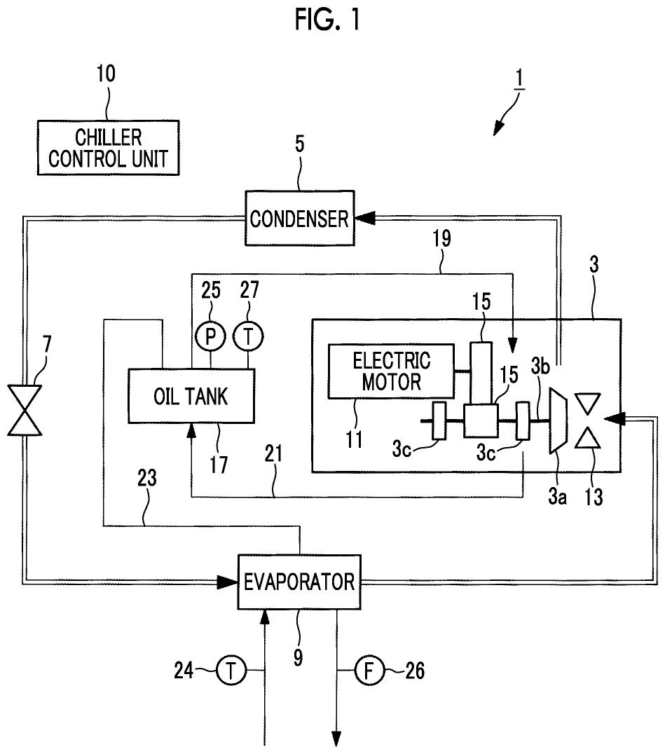

FIG. 1 is a schematic configuration diagram illustrating a centrifugal chiller according to an embodiment of the present invention. As illustrated in FIG. 1, a centrifugal chiller 1 includes a compressor 3 which compresses a refrigerant, a condenser 5 which condenses a high-temperature and high-pressure gas refrigerant compressed by the compressor 3, an expansion valve 7 which expands a liquid refrigerant introduced from the condenser 5, an evaporator 9 which evaporates the liquid refrigerant expanded by the expansion valve 7, and a chiller control unit 10 which controls the centrifugal chiller 1.

As the refrigerant, a low-pressure refrigerant referred to as HFO-1233zd (E) is used.

For example, a turbo compressor is used for the compressor 3. The compressor 3 is driven by an electric motor 11 of which a rotating speed is controlled by an inverter. The output of the inverter is controlled by the chiller control unit 10. In the present embodiment, a variable speed compressor will be described as an example, but a fixed speed compressor may be used.

An inlet guide vane (hereinafter, referred to as “IGV”) 13 which controls a flow rate of a sucked refrigerant is provided in a refrigerant intake port of the compressor 3, and thus, capacity of the centrifugal chiller 1 can be controlled by the IGV 13. An opening degree of the IGV 13 is controlled by the chiller control unit 10.

The compressor 3 includes an impeller 3a which rotates around a rotary shaft 3b. Rotational power is transmitted from the electric motor 11 to the rotary shaft 3b via a speed increasing gear 15. The rotary shaft 3b is supported by a bearing 3c.

The condenser 5 is a shell and tube type heat exchanger or a plate type heat exchanger. Cooling water for cooling the refrigerant is supplied to the condenser 5. Heat of the cooling water introduced to the condenser 5 is discharged to the outside by a cooling tower (not illustrated) or an air heat exchanger (not illustrated), and thereafter, the cooling water is introduced to the condenser 5 again.

The expansion valve 7 is of an electric expansion valve, and an opening degree of the expansion valve 7 is set by the chiller control unit 10.

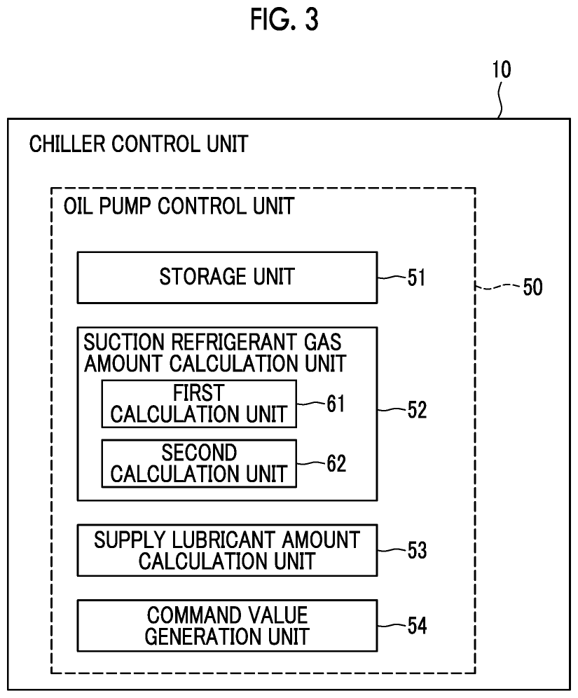

The evaporator 9 is a shell and tube type heat exchanger or a plate type heat exchanger. Chilled water supplied to an external load (not illustrated) is introduced to the evaporator 9. The chilled water is cooled to a rated temperature (for example, 7° C.) by heat exchange between the chilled water and the refrigerant in the evaporator 9, and is fed to the external load. A temperature sensor 24 for measuring a chilled water inlet temperature is provided in a pipe for supplying the chilled water to the evaporator 9. A flow rate sensor 26 for measuring a flow rate of the chilled water is provided in a pipe for supplying the chilled water cooled by the evaporator 9 to the external load. The chilled water inlet temperature measured by the temperature sensor 24 and the flow rate of the chilled water measured by the flow rate sensor 26 are transmitted to the chiller control unit 10 and are used for the overall control of the centrifugal chiller such as being used by an oil pump control unit 50 (refer to FIG. 3) described later.

The lubricant is supplied from the oil tank 17 to the bearing 3c or the speed increasing gear 15 of the compressor 3. For example, a synthetic oil or a mineral oil is used as the lubricant.

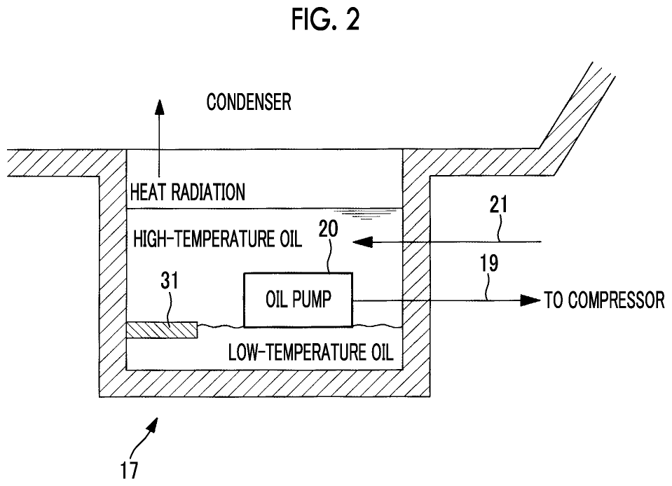

An oil pump 20 (refer to FIG. 2) is provided in the oil tank 17, and thus, the lubricant is supplied at a predetermined flow rate through an oil supply pipe 19. The lubricant which has lubricated the inside of the compressor 3 is returned to the oil tank 17 via an oil return pipe 21. The oil pump 20 is a variable speed pump of which a rotating speed is variable, and is driven by an electric motor (not illustrated) of which a rotating speed is controlled by an inverter (not illustrated), for example. The output of the inverter is controlled by the chiller control unit 10.

A pressure equalizing pipe 23 which communicates between the oil tank 17 and the evaporator 9 is provided therebetween to equalize a pressure in the oil tank 17 and a pressure in the evaporator 9. In this way, the pressure in the oil tank 17 decreases, and thus, a refrigerant elution amount with respect to the lubricant is kept low.

A pressure sensor 25 and a temperature sensor 27 are provided in the oil tank 17. The pressure in the oil tank 17 measured by the pressure sensor 25 and the temperature (specifically, the temperature of the lubricant) in the oil tank 17 measured by the temperature sensor 27 are sent to the chiller control unit 10.

FIG. 2 is a diagram schematically illustrating a configuration of the oil tank 17. As illustrated in FIG. 2, an oil heater 31 for heating lubricant stored in the oil tank 17 is provided in the oil tank 17. For example, ON/OFF of the oil heater 31 is controlled by the chiller control unit 10 so that the lubricant in the oil tank has an approximately constant temperature, based on the temperature measured by the temperature sensor 27.

For example, the oil heater 31 is provided at a position separated from a bottom surface of the oil tank by a predetermined distance upward. Since the oil heater 31 is provided at the position, the lubricant having a relatively low temperature stays in a region below an installation position of the oil heater 31, and the lubricant having a relatively high temperature stays in a region above the installation position of the oil heater 31. This temperature distribution of the lubricant is generated every time the oil heater 31 starts and stops.

When the oil pump 20 starts, foaming is likely to occur due to various factors such as a pressure reduction speed on a low-pressure side or the temperature distribution of the lubricant in the oil tank 17 described above. For example, as described above, in a case where the temperature distribution of the lubricant is large, the lubricant having a relatively high temperature and the lubricant having a relatively low temperature come into contact with each other in the vicinity of an intake port of the oil pump 20, and thus, a refrigerant gas is generated.

For example, the chiller control unit 10 is configured to include a Central Processing Unit (CPU), a Random Access Memory (RAM), a Read Only Memory (ROM), a computer readable storage medium, or the like. For example, a series of processing for the chiller control unit 10 to realize various functions is stored in a storage medium or the like in the form of a program (for example, an oil pump control program), and the CPU causes a RAM or the like to read the program and executes information processing/calculation processing to realize various functions. The program may be installed in the ROM or other storage medium in advance, may be provided in a state of being stored in a computer readable storage medium, or may be delivered via wired or wireless communication means. The computer readable storage medium is a magnetic disk, a magneto-optical disk, a CD-ROM, a DVD-ROM, a semiconductor memory, or the like.

FIG. 3 is a functional block diagram illustrating the oil pump control unit (oil pump control device) 50 which is one of functions for reducing an influence of the foaming on the compressor 3 out of various functions of the chiller control unit 10.

In the present embodiment, a case where the chiller control unit 10 for controlling the centrifugal chiller 1 includes the oil pump control unit 50 will be described as an example. However, the present invention is not limited to this example, and for example, the oil pump control unit for controlling the oil pump 20 may be provided independently of the chiller control unit 10 for controlling the centrifugal chiller.

The oil pump control unit 50 mainly includes a storage unit 51, a suction refrigerant gas amount calculation unit 52, a supply lubricant amount calculation unit 53, and a command value generation unit 54.

Various information necessary for the oil pump control unit 50 to control the oil pump 20 is stored in the storage unit 51. As one of various information, refrigerant solubility information in which refrigerant solubility and a pressure are associated with each other is stored. A description format of the refrigerant solubility information may be a map format or a relational expression using an approximate expression or the like.

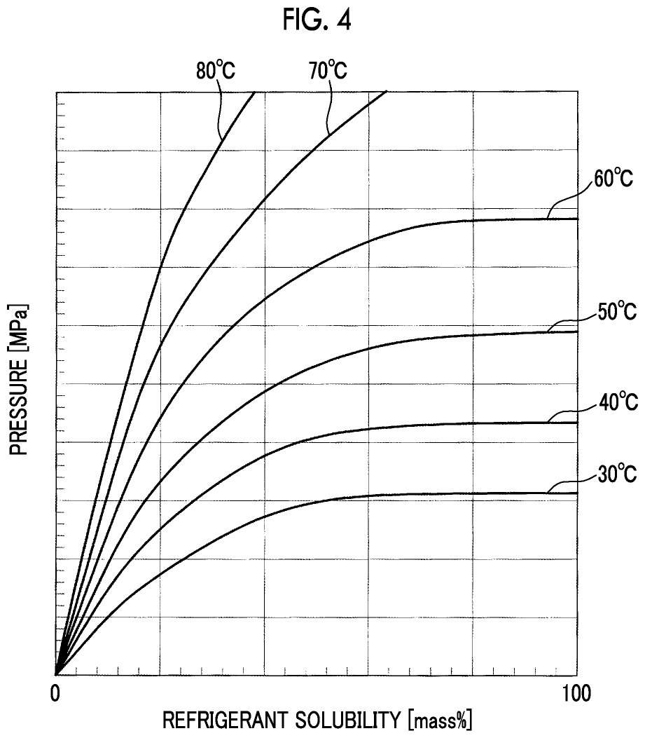

FIG. 4 illustrates an example of the refrigerant solubility information. In FIG. 4, a horizontal axis is the refrigerant solubility [mass % (mass percent)] indicating a ratio of an amount of the dissolved refrigerant with respect to the lubricant by a mass ratio, and a vertical axis is the pressure [MPa]. Each curve illustrated in FIG. 4 indicates the refrigerant solubility at each temperature (for example, lubricant temperature). As can be seen from FIG. 4, each curve has an upwardly convex shape, and as the pressure decreases, the refrigerant solubility decreases. Moreover, as the pressure decreases, a change in the refrigerant solubility increases. Further, when compared at the same pressure, it can be seen that as the lubricant temperature increases, the refrigerant solubility decreases.

The suction refrigerant gas amount calculation unit 52 includes a first calculation unit 61 which calculates a refrigerant elution amount using the refrigerant solubility information stored in the storage unit 51, and a second calculation unit 62 which calculates an amount of the refrigerant gas sucked by the oil pump 20 using the refrigerant elution amount calculated by the first calculation unit 61, as an suction refrigerant gas amount.

Here, the “refrigerant elution amount” means a volume of the refrigerant gas discharged from the lubricant as the refrigerant dissolved in the lubricant stored in the oil tank 17 is a gas. The “suction refrigerant gas amount” means a volume of the refrigerant gas which is estimated to be sucked into the oil pump 20 out of the “refrigerant elution amount”. The detailed processing contents of the first calculation unit 61 and the second calculation unit 62 will be described later.

The supply lubricant amount calculation unit 53 calculates a supply lubricant amount using the suction refrigerant gas amount which is a calculation result of the suction refrigerant gas amount calculation unit 52 and a required supply amount which is a lubricant amount required by the compressor 3. For example, the supply lubricant amount calculation unit 53 adds the required supply amount to the suction refrigerant gas amount to calculate the supply lubricant amount. Here, for example, the required supply amount is a preset value determined from a machine configuration (for example, a size of a bearing or a gear), and is constant regardless of operating conditions.

The command value generation unit 54 generates a rotating speed command value of the oil pump 20 based on the supply lubricant amount calculated by the supply lubricant amount calculation unit 53. For example, the command value generation unit 54 has pump characteristic information in which the rotating speed and an oil supply amount (discharge amount) of the oil pump 20 are associated with each other, acquires a rotating speed corresponding to the supply lubricant amount from this pump characteristic information, and outputs this rotating speed as a rotating speed command value to a drive portion (not illustrated) which drives the oil pump 20.

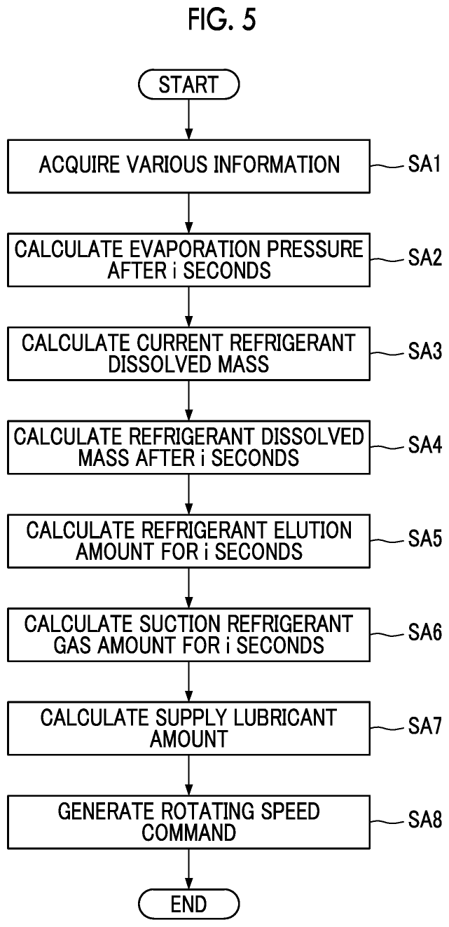

Next, an oil pump control method performed by the oil pump control unit 50 according to the present embodiment will be described with reference to FIG. 5. FIG. 5 is a flowchart illustrating a procedure of the oil pump control method performed by the oil pump control unit 50. For example, the oil pump control described below may be performed in a state where the foaming is likely to occur such as when the compressor is started, and may be performed at the time of a transient operation in which an evaporation pressure is changed.

First, the “refrigerant elution amount” is calculated by the first calculation unit 61 of the suction refrigerant gas amount calculation unit 52 (SA1 to SA5).

Specifically, in Step SA1, various information necessary for calculating the refrigerant elution amount is acquired. For example, Pe(tc−i), Pe(tc), Toil, TL1, and Fch are acquired. Here, Pe(tc−i) is an evaporation pressure before i seconds (for example, before 10 seconds), Pe(tc) is a current evaporation pressure, and both are values measured by the pressure sensor 25. As described above, the pressure equalizing pipe 23 communicating between the oil tank 17 and the evaporator 9 is provided therebetween, and thus, the pressure in the oil tank 17 has the same value as the evaporation pressure.

Toil is a current oil tank temperature, and, for example, a value measured by the temperature sensor 27 is used for the Toil. TL1 is a current chilled water inlet temperature and is a value measured by the temperature sensor 24. Fch is a current chilled water flow rate and is a value measured by the flow rate sensor 26.

Next, the evaporation pressure Pe(tc+i) after i seconds is calculated from a pressure change amount ΔPe=Pe(tc)−Pe(tc−i) during past i seconds (SA2). Here, assuming that the evaporation pressure changes by the same pressure change amount, the evaporation pressure Pe(tc+i) after i seconds is calculated by the following Expression (1). Here, i is an integer which is voluntarily set, and is 10 seconds, for example.

Pe(tc+i)=Pe(tc)+ΔPe (1)

Subsequently, a current refrigerant dissolved mass is calculated (SA3). Specifically, the current refrigerant solubility is acquired from the current oil tank temperature Toil, the current evaporation pressure Pe(tc), and the refrigerant solubility information illustrated in FIG. 4, and the current refrigerant dissolved mass is calculated from the acquired refrigerant solubility, a current lubricant density, and an amount of the lubricant stored in the oil tank 17. For example, the current refrigerant dissolved mass is calculated by multiplying the current refrigerant solubility, the current lubricant density, and the amount of the lubricant stored in the oil tank 17.

Next, the refrigerant dissolved mass after i seconds is calculated in the same procedure (SA4). Specifically, the refrigerant solubility after i seconds is calculated from the current oil tank temperature Toil, the evaporation pressure Pe(tc+i) after i seconds, and the refrigerant solubility information illustrated in FIG. 4, and the refrigerant dissolved mass after i seconds is calculated by multiplying the acquired refrigerant solubility, the current lubricant density, and the amount of the lubricant stored in the oil tank.

Next, a refrigerant elution amount for i seconds is calculated using the current refrigerant dissolved mass calculated in Step SA3 and the refrigerant dissolved mass after i seconds calculated in Step SA4 (SA5). For example, the refrigerant elution amount Vrefd for i seconds is calculated by the following Expression (2).

Vrefd=[Mre(tc)−Mre(tc+i)]/ρrefg(tc+i)×10³ (2)

In the Expression (2), Vrefd is the refrigerant elution amount for i seconds, Mre(tc) is the current refrigerant dissolved mass calculated in Step SA3, Mre(tc+i) is the refrigerant dissolved mass after i seconds calculated in Step SA4, and prefg(tc+i) is a refrigerant gas density after i seconds. Here, the refrigerant gas density after i seconds is a value determined by a function having the evaporation pressure Pe(tc+i) after i seconds and a degree of superheat after i seconds as parameters. Here, the refrigerant gas density decreases as the evaporation pressure decreases. In other words, since an amount of gas appearing at the same appearing mass increases, a safe side is used and a value after i seconds is used. When a saturated gas density is used, the gas density is larger than an actual gas density. In other words, a refrigerant gas appearance volume decreases, and thus, the safe side is taken and a heated gas density (degree of superheat) is adopted.

In this manner, when the refrigerant elution amount for i seconds (an amount of foaming generated from the oil tank 17) is calculated by the first calculation unit 61, subsequently, the suction refrigerant gas amount for i seconds (an amount of foaming sucked into the oil pump) is calculated by the second calculation unit 62 (SA6).

Specifically, the suction refrigerant gas amount is calculated using the refrigerant elution amount for i seconds calculated by the first calculation unit 61, the current discharge amount of the oil pump, and the lubricant amount stored in the oil tank 17. For example, the suction refrigerant gas amount after i seconds is calculated by multiplying the refrigerant elution amount for i seconds by a ratio of the amount of lubricant discharged from the oil pump 20 with respect to the amount of lubricant stored in the oil tank 17. For example, the suction refrigerant gas amount after i seconds is represented by the following Expression (3).

Vrefdp=Foilp(tc)/Voil×Vrefd (3)

In the Expression (3), Foilp(tc) is a current discharge amount of the oil pump, Voil is an amount of lubricant stored in the oil tank 17, and Vrefd is the refrigerant elution amount for i seconds calculated by the first calculation unit 61.

Subsequently, the supply lubricant amount is calculated by the supply lubricant amount calculation unit (SA7). Specifically, the supply lubricant amount is calculated by adding the suction refrigerant gas amount after i seconds calculated by the second calculation unit 62 and the required supply amount which is the amount of lubricant required by the compressor 3.

For example, the supply lubricant amount Foilp(tc+i) for one minute is represented by the following Expression (4).

Foilp(tc+i)=Foil_r+Vrefdp/i×60 (4)

In the Expression (4), Foil r is the required supply amount.

Subsequently, the rotating speed command value of the oil pump 20 is generated by the command value generation unit 54 (SA8). Specifically, the command value generation unit 54 determines whether or not the supply lubricant amount calculated by the supply lubricant amount calculation unit 53 exceeds a specification value (for example, a discharge amount corresponding to a rotating speed upper limit value) of the oil pump 20. In a case where the supply lubricant amount exceeds the specification value, the command value generation unit 54 replaces the supplied lubrication with the specification value and generates a rotating speed command value based on the specification value. Meanwhile, in a case where the supplied lubricant is equal to or less than the specification value, the command value generation unit 54 generates a rotating speed command value corresponding to the supplied lubricant.

In addition, it is possible to prevent shortage of the lubricant supplied to the compressor 3 by repeatedly performing the above-described processing at predetermined time intervals. The flow of the oil pump control described above is an example, and an unnecessary step may be deleted, a new step may be added, or a processing order may be changed within a scope which does not depart from the gist of the present invention.

As described above, according to the oil pump control device, the control method, the control program, and the centrifugal chiller of the present embodiment, the amount of refrigerant gas sucked by the oil pump 20 is calculated as the suction refrigerant gas amount by the suction refrigerant gas amount calculation unit 52, and the supply lubricant amount is calculated by the supply lubricant amount calculation unit 53 using the suction refrigerant gas amount and the required lubricant amount which is the amount of lubricant required by the compressor 3. In addition, the command value generation unit 54 generates the rotating speed command value of the oil pump 20 based on the supply lubricant amount.

In this way, the supply lubricant amount is calculated in consideration of the refrigerant gas amount sucked by the oil pump 20, and the rotating speed of the oil pump 20 is controlled according to the supply lubricant amount. Accordingly, it is possible to prevent the amount of lubricant supplied to the compressor 3 being insufficient due to the occurrence of the foaming.

Therefore, it is possible to reduce an influence on the compressor 3 due to occurrence of the foaming in the oil tank.

A technical scope of the present invention is not limited to a scope described in the embodiment. Various modifications or improvements can be made to the embodiment within a scope which does not depart from the gist of the invention, and an embodiment to which the modifications and the improvements are applied is also included in the technical scope of the present invention. The embodiments may be appropriately combined.

For example, in the present embodiment, HFO-1233zd (E) is described as an example of the low-pressure refrigerant. However, the present invention can be applied to other low-pressure refrigerants, and in a case where there is a concern that the foaming may occur in the oil tank, the present invention can be applied to a high-pressure refrigerant.

The centrifugal chiller 1 according to the present embodiment has the oil pump control unit 50 as the function for reducing the influence of the foaming. However, in addition to this, for example, the centrifugal chiller 1 may have an evaporation pressure adjustment function for reducing the pressure of the evaporator 9 at an appropriate speed.

For example, the evaporation pressure adjustment function is a function for preventing the following events from occurring.

For example, in a case where the foaming occurs, the lubricant may be foamed, an oil level may rise, and the lubricant may flow from the oil tank 17 to the evaporator 9 through the pressure equalizing pipe 23. In this case, if the lubricant is attached to a heat exchange tube of the evaporator 9, performance (an amount of heat exchange) of the evaporator 9 may be reduced. The refrigerant gas discharged from the lubricant is determined according to a pressure difference generated within a predetermined time. Therefore, in a case where a decompression speed is high, the oil level may rise sharply due to the refrigerant gas discharged at once. Accordingly, in order to prevent the above-described events, it is necessary adjust the evaporation pressure at an appropriate speed so as to adjust the amount of foaming.

Moreover, for example, according to the evaporation pressure adjustment function, the refrigerant gas elution amount for i seconds is calculated by the same method as the above-described first calculation unit 61, and how much space is left on the oil surface of the oil tank is determined from the refrigerant gas elution amount, a capacity of the oil tank 17, and the amount of lubricant which is always stored in the oil tank. In addition, the evaporation pressure is adjusted so as to suppress the amount of foaming to such an extent that a space is always maintained above the oil tank 17. Specifically, a set value of a chilled water outlet temperature in the evaporator 9 is adjust to control the evaporation pressure.

As described above, according to the evaporation pressure adjustment function, the evaporation pressure is reduced stepwise or gradually in consideration of the refrigerant gas elution amount, and thus, the influence due to the foaming can be reduced.

In addition, the above-described evaporation pressure adjustment function and the oil pump control function according to the present embodiment are provided together, and thus, it is possible to further reduce the influence on the compressor 3 or the like due to the occurrence of the foaming.

### REFERENCE SIGNS LIST

1: centrifugal chiller
3: compressor
5: condenser
7: expansion valve
9: evaporator
10: chiller control unit
17: oil tank
20: oil pump
23: pressure equalizing pipe
24: temperature sensor
25: pressure sensor
26: flow rate sensor
27: temperature sensor
31: oil heater
50: oil pump control unit
51: storage unit
52: suction refrigerant gas amount calculation unit
53: supply lubricant amount calculation unit
54: command value generation unit
61: first calculation unit
62: second calculation unit

1. An oil pump control device which is applied to a centrifugal chiller including an oil tank for storing a lubricant to be supplied to a compressor, and an oil pump having a variable rotating speed and supplying the lubricant in the oil tank to the compressor, the control device comprising:
a suction refrigerant gas amount calculation unit which calculates an amount of refrigerant gas sucked by the oil pump, as a suction refrigerant gas amount;
a supply lubricant amount calculation unit which calculates a supply lubricant amount using the suction refrigerant gas amount and a required lubricant amount which is a lubricant amount required by the compressor; and
a command value generation unit which generates a rotating speed command value of the oil pump based on the supply lubricant amount;
wherein the suction refrigerant gas amount calculation unit includes
a first calculation unit which calculates an amount of refrigerant gas generated from the lubricant in the oil tank, and
a second calculation unit which calculates the amount of refrigerant gas sucked by the oil pump using the amount of refrigerant gas calculated by the first calculation unit.

2. (canceled)

3. A centrifugal chiller comprising:
a compressor which compresses a refrigerant;
a condenser which condenses the refrigerant compressed by the compressor;
an expansion valve which expands a liquid refrigerant introduced from the condenser;
an evaporator which evaporates the refrigerant expanded by the expansion valve;
an oil tank which stores a lubricant to be supplied to the compressor;
an oil pump which has a variable rotating speed and supplies the lubricant in the oil tank to the compressor; and
the oil pump control device according to claim 1.

4. An oil pump control method which is applied to a centrifugal chiller including an oil tank for storing a lubricant to be supplied to a compressor, and an oil pump having a variable rotating speed and supplying the lubricant in the oil tank to the compressor, the control method comprising:
a step of calculating an amount of refrigerant gas sucked by the oil pump, as a suction refrigerant gas amount;
a step of calculating a supply lubricant amount using the suction refrigerant gas amount and a required lubricant amount which is a lubricant amount required by the compressor; and
a step of generating a rotating speed command value of the oil pump based on the supply lubricant amount;
wherein the step of calculating the amount of refrigerant gas includes
a step of first calculation which calculates an amount of refrigerant gas generated from the lubricant in the oil tank, and
a step of second calculation which calculates the amount of refrigerant gas sucked by the oil pump using the amount of refrigerant gas calculated by the step of first calculation.

5. An oil pump control program which is applied to a centrifugal chiller including an oil tank for storing a lubricant to be supplied to a compressor, and an oil pump having a variable rotating speed and supplying the lubricant in the oil tank to the compressor, the control program causing a computer to execute:
processing of calculating an amount of refrigerant gas sucked by the oil pump, as a suction refrigerant gas amount;
processing of calculating a supply lubricant amount using the suction refrigerant gas amount and a required lubricant amount which is a lubricant amount required by the compressor; and
processing of generating a rotating speed command value of the oil pump based on the supply lubricant amount;
wherein processing of calculating the amount of refrigerant gas includes
processing of first calculation which calculates an amount of refrigerant gas generated from the lubricant in the oil tank, and
processing of second calculation which calculates the amount of refrigerant gas sucked by the oil pump using the amount of refrigerant gas calculated by the step of first calculation.
